(19) United States
(12) Patent Application Publication
(10) Pub. No.: US 2019/0301891 A1
(43) Pub. Date: Oct. 3, 2019

(54) Method and Apparatus for Obtaining and Displaying Map Data On a Mobile Device

(71) Applicant: QUALCOMM Incorporated, San Diego, CA (US)

(72) Inventor: Douglas Neal Rowitch, Honolulu, HI (US)

(21) Appl. No.: 15/939,846

(22) Filed: Mar. 29, 2018

(51) Int. Cl. G01C 21/36; G01C 21/34

(52) U.S. Cl. CPC G01C 21/3697; G01C 21/3492; G01C 21/3415; G01C 21/3667

(57) ABSTRACT

Techniques are provided which may be implemented using various methods and/or apparatuses in a mobile device to display a map. Techniques are provided which may be implemented using various methods and/or apparatuses on a mobile device to display a map comprising a road segment associated with an uncertain driving condition associated with appropriate status information, and to determine whether the uncertain driving condition is due to a lack of data resulting from a lack of traffic or whether the uncertain driving condition is due to a road closure or comparable event.

### BACKGROUND

### 1. Field

The subject matter disclosed herein relates to electronic devices, and more particularly to methods and apparatuses for use in or with a mobile device to facilitate the receiving and displaying of road segment status at a mobile device.

### 2. Information

Mobile devices are utilized to provide map and navigation information. Accidents, road closures, acts of nature and other events may impact the status of a road segment along a route. Status information for a road segment may not be available from government sources or, if available, is either late or not integrated into map information. Similarly, applications that rely on explicit user reports may not be reliable, particularly in low to moderate traffic scenarios where there is a good chance that no explicit reports will be sent in. Furthermore, not all mobile devices and/or automobiles support explicit user reporting of road events and/or status and, in some situations, no user report may be sent to the server reporting a given road events or status and/or such report may be greatly delayed, leading to slow or no reporting of road events. Therefore, there is a need for road status information that can be determined by crowdsourcing mobile devices without requiring explicit user action to report and/or detect road events.

### SUMMARY

Some example techniques are presented herein which may be implemented in various method and apparatuses in a mobile device to request map information and to receive and display road segment status information based. In various embodiments, mobile devices may be used to gather information on road segments, to request road segment information and to display updated road segment information. In various embodiments, a map server and/or a crowd source server may be utilized to collect and analyze information on various road segments. The map sever may, in various embodiments, provide updated road segment information relative to accessibility and route preference.

In accordance with an example implementation, a method may be provided which comprises, sending a request, from the mobile device, for map information, to a map server or to a navigation server, comprising an indication of a current location of the mobile device; receiving, at the mobile device, the map information comprising a road segment associated with an uncertain driving condition; displaying, on the mobile device, the map comprising the road segment associated with the uncertain driving condition and an associated indication of a road closure; and displaying, on the mobile device, an updated map, based at least in part upon elimination of the uncertain driving condition, comprising the road segment associated with the eliminated uncertain driving condition and an indication of driving condition for the road segment associated with the eliminated uncertain driving condition.

In accordance with another example implementation, an apparatus may be provided for use in a mobile device comprising: means for sending a request, from the mobile device, for map information, to a map server or to a navigation server, comprising an indication of a current location of the mobile device; means for receiving, at the mobile device, the map information comprising a road segment associated with an uncertain driving condition; means for displaying, on the mobile device, the map comprising the road segment associated with the uncertain driving condition and an associated indication of a road closure; and means for displaying, on the mobile device, an updated map, based at least in part upon elimination of the uncertain driving condition, comprising the road segment associated with the eliminated uncertain driving condition and an indication of driving condition for the road segment associated with the eliminated uncertain driving condition.

In accordance with yet another example implementation, a mobile device may be provided which comprises: one or more processing units; and a display coupled to the one or more processing units; and a wireless transceiver coupled to the one or more processing units; wherein the one or more processing units are configured to: send a request, from the mobile device, for map information, to a map server or to a navigation server, comprising an indication of a current location of the mobile device; receive, at the mobile device, the map information comprising a road segment associated with an uncertain driving condition; display, on the mobile device, the map comprising the road segment associated with the uncertain driving condition and an associated indication of a road closure; and display, on the mobile device, an updated map, based at least in part upon elimination of the uncertain driving condition, comprising the road segment associated with the eliminated uncertain driving condition and an indication of driving condition for the road segment associated with the eliminated uncertain driving condition.

In accordance with an example implementation, a non-transitory computer-readable medium may be provided, having stored thereon computer-readable instructions for to cause a processor to: send a request, from a mobile device, for map information, to a map server or to a navigation server, comprising an indication of a current location of the mobile device; receive, at the mobile device, the map information comprising a road segment associated with an uncertain driving condition; display, on the mobile device, a map comprising the road segment associated with the uncertain driving condition and an associated indication of a road closure; and display, on the mobile device, an updated map, based at least in part upon elimination of the uncertain driving condition, comprising the road segment associated with the eliminated uncertain driving condition and an indication of driving condition for the road segment associated with the eliminated uncertain driving condition.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a system diagram including wireless-capable mobile devices, capable of receiving and displaying map information.

FIG. 2 is an exemplary mobile device capable of receiving and displaying map information.

FIG. 3 is an exemplary network-based server, as may be used for a location server, a map server, a crowd source server, a navigation server, an application server or other network-based server.

FIG. 4 illustrates an embodiment for requesting, receiving and displaying route information on a mobile device.

FIG. 5 illustrates an embodiment for crowd sourcing information relating to an uncertain road segment at a server and for updating road segment status on mobile devices.

FIG. 6 illustrates an exemplary map illustrating a road segment associated with an uncertain driving condition.

### DETAILED DESCRIPTION

Some example techniques are presented herein which may be implemented in various methods, means and apparatuses in a mobile device and in a crowd sourcing and information delivery system. Example techniques presented herein address various methods and apparatuses in a mobile device to provide for or otherwise support the provision of map information comprising road segment information. Example techniques and embodiments are provided for requesting map information, by a mobile device, from a map server, comprising road segment information. Example techniques and embodiments are provided for receiving road segment information from a plurality of mobile devices, by a crowd source server or by a map server, and for providing updated map information based upon the received road segment information.

In the case of crowdsourcing road segment data, vehicle speeds may be crowdsourced from vehicles (containing mobile devices 100, utilizing the mobile devices 100 to measure location, velocity or speed and/or heading) on a particular segment of road, thereby providing an estimate of speeds along that segment of road. However, crowd sourcing vehicle speeds along a particular segment of road, generally requires that mobile devices 100 capable of providing traffic data (via the location, velocity or speed and/or heading of mobile devices as provided by the mobile devices 100) be present on that segment of road and provide location, heading and/or velocity or speed information to a crowd source server or to a map server or other server capable of accumulating and analyzing road data.

In the case of road closures, particularly in areas where road closure data is not readily available online such as in rural areas or smaller municipalities or counties, it will may be very difficult to detect a road closure or severe slow down. A road closure or severe slowdown may, in some cases, be attributed to road maintenance and/or new construction, events, such as marathons, group runs or parades, that block a road, traffic or accidents, mud or snow slides and other events that cause a road blockage or closure. If no cars traverse a road segment or, at least, if no cars that are actively crowdsourcing road data, traverse a road segment, it may be very difficult or impossible to determine if a road is closed, if traffic is slowed or constricted or if other traffic blocking event has occurred. This may result in uncertainty relative to particular road segments and may expose drivers that take those particular road segments to greater risk of being stuck behind a road blocking event.

In some embodiments, a crowd sourcing server would show road segments with no traffic in an undetermined state since no crowd sourced traffic data would be available for that segment. For example, in an embodiment instead of showing a segment as green (available) or red (blocked or slow), a segment may be illustrated as dotted or white to designate a lack of crowd sourced data for that segment.

In some embodiments, the uncertainty associated with road segments that are not being crowdsourced can be reduced or eliminated by comparing current traffic patterns against historical traffic patterns for a comparable time of day and day of week. In an embodiment, if a road segment that has historically high or at least moderate traffic for a comparable time of day and day of week shows no traffic or only significantly slower traffic or only local traffic, a road closure or traffic blocking event may be inferred. In an embodiment, when a road closure or traffic blocking event is inferred, a notification may be sent from a map server, or from a navigation sever, or other application and/or road information sever, to mobile devices of the inferred road closure or traffic blocking event. In an embodiment, when a road closure or traffic blocking event is inferred, a map server or a navigation sever, or other application and/or road information sever, may use the event inference in its navigation routing algorithms to select or to recommend or to more highly rank alternative routes that do not involve the road closure or traffic blocking even. In an embodiment, if a road segment for which a road closure or traffic blocking event was previously inferred, registered flowing traffic, the road closure or traffic blocking event may be removed or modified (for example, to show slow traffic instead of a road closure or to lower the confidence associated with the road closure or to estimate a more accurate location of the road closure along a road segment). In an embodiment, if an area nearby to or leading to a road segment shows significant diverted traffic to an alternative road segment, a road closure or road blocking event may be inferred, or if already inferred, the confidence associated with the road closure or road blocking event may be increased.

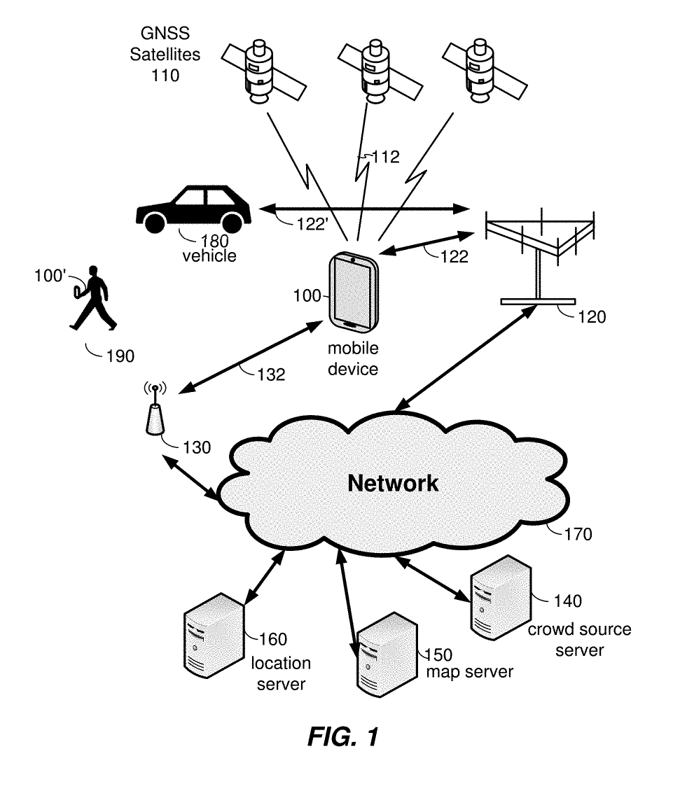

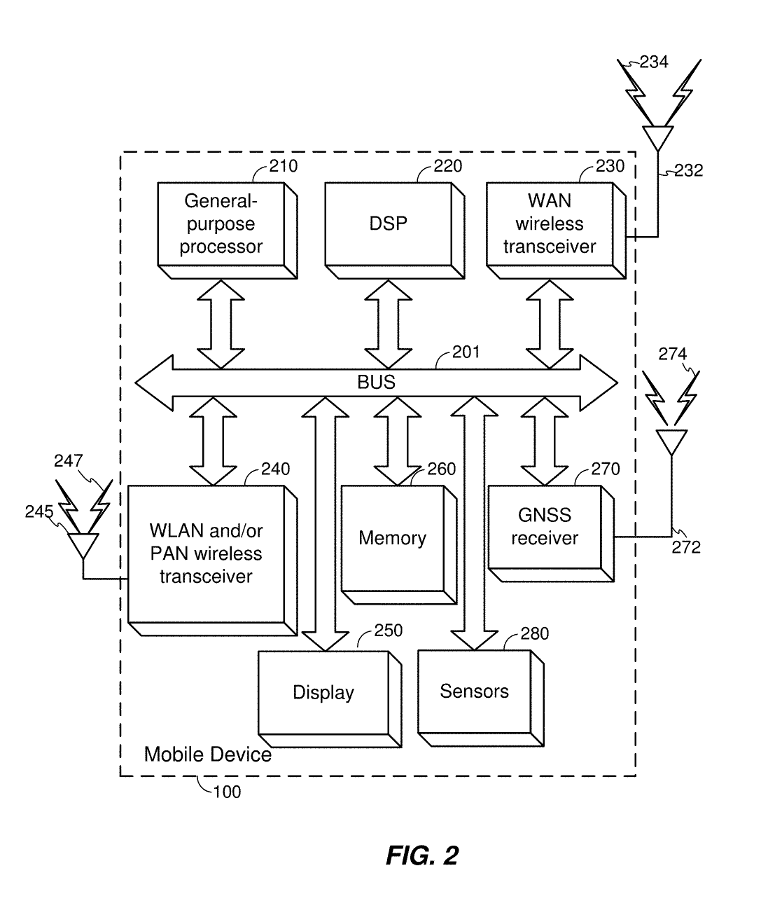

FIG. 1 illustrates a system and means for implementing the various methods and techniques described in the figures and text herein. As shown in FIG. 2, in an embodiment, mobile device 100, which may also be referred to as a UE (or user equipment), may transmit radio signals to, and receive radio signals from, a wireless communication network. In one example, mobile device 100 may communicate, via wide area network (WAN) wireless transceiver 120 and wireless antenna 232 with a cellular communication network by transmitting wireless signals to, or receiving wireless signals from a WAN wireless transceiver 120 which may comprise a wireless base transceiver subsystem (BTS), a Node B or an evolved NodeB (eNodeB) or a next generation NodeB (gNodeB) or other WAN wireless transceiver 120 over wireless communication link 122. Similarly, mobile device 100 may transmit wireless signals to, or receive wireless signals from local transceiver 130 over wireless communication link 132, for example, by using wireless local area network (WLAN) and/or personal area network (PAN) wireless transceiver 240 and antenna 245. In an embodiment, local transceiver 130 may be a WLAN access point, a Bluetooth transceiver, a ZigBee transceiver, or other WLAN or PAN transceiver. A local transceiver 130 and/or a WAN wireless transceiver 120 may comprise an access point (AP), femtocell, Home Base Station, small cell base station, Home Node B (HNB), Home eNodeB (HeNB), eNodeB or next generation NodeB (gNodeB) and may provide access to a wireless local area network (WLAN, e.g., IEEE 802.11 network), a wireless personal area network (PAN, e.g., Bluetooth® network) or a cellular network (e.g. an LTE network or other wireless wide area network such as those discussed in the next paragraph). Of course, it should be understood that these are merely examples of networks that may communicate with a mobile device over a wireless link, and claimed subject matter is not limited in this respect. In an embodiment, GNSS signals 112 from GNSS Satellites 110 are utilized by mobile device 100 for location determination. In an embodiment, signals 122 from WAN transceiver(s) 120 and signals 132 from WLAN and/or PAN local transceivers 130 are used for location determination, alone or in combination with GNSS signals 112. In an embodiment, mobile user 190 has a mobile device 100′, an embodiment of mobile device 100, which may be utilized to request a map information and/or navigation information; in an embodiment, mobile user 190 may be located in vehicle.

Examples of network technologies that may support wireless transceiver 230 and WAN wireless transceiver 120 are Global System for Mobile Communications (GSM), Code Division Multiple Access (CDMA), Wideband CDMA (WCDMA), Long Term Evolution (LTE), 5th Generation Wireless (5G) or New Radio Access Technology (NR), High Rate Packet Data (HRPD). GSM, WCDMA and LTE are technologies defined by 3GPP. CDMA and HRPD are technologies defined by the 3^{rd} Generation Partnership Project 2 (3GPP2). WCDMA is also part of the Universal Mobile Telecommunications System (UMTS) and may be supported by an HNB. WAN wireless transceivers 120 may comprise deployments of equipment providing subscriber access to a wireless telecommunication network for a service (e.g., under a service contract). Here, a WAN wireless transceiver 120 may perform functions of a wide area network (WAN) or cell base station in servicing subscriber devices within a cell determined based, at least in part, on a range at which the WAN wireless transceiver 120 is capable of providing access service. Examples of WAN base stations include GSM™, WCDMA™, LTE™, CDMA™, HRPD™ WiFi™, BT, WiMax™, and/or 5th Generation (5G) base stations. In an embodiment, further wireless transceivers 240 may comprise a wireless LAN (WLAN) and/or PAN transceiver. In an embodiment, mobile device 100 may contain multiple wireless transceivers including WAN, WLAN and/or PAN transceivers. In an embodiment, radio technologies that may support wireless communication link or links (wireless transceiver 240) further comprise Wireless local area network (e.g., WLAN, e.g., IEEE 802.11), Bluetooth™ (BT) and/or ZigBee™.

In an embodiment, mobile device 100, using wireless transceiver(s) 230 or 240, may communicate with crowd source server 140, map server 150 and/or location sever 160 over a network 170 through communication interface(s) 308. In an embodiment, mobile device 100, using wireless transceivers 230 or 240, may communicate with other servers such as a navigation, application or route server over network 170 through communication interface(s) 308. Here, network 170 may comprise any combination of wired or wireless connections and may include WAN wireless transceiver 120 and/or local transceiver 130 and/or servers 140, 150 and/or 160 or other servers. In an embodiment, network 170 may comprise Internet Protocol (IP) or other infrastructure capable of facilitating communication between mobile device 100 and servers 140, 150 and/or 160 through local transceiver 130 or WAN wireless transceiver 120. In an embodiment, network 170 may comprise cellular communication network infrastructure such as, for example, a base station controller or packet based or circuit based switching center (not shown) to facilitate mobile cellular communication with mobile device 100. In an embodiment, network 170 may comprise local area network (LAN) elements such as Wi-Fi APs, routers and bridges and may in that case include or have links to gateway elements that provide access to wide area networks such as the Internet. In other implementations, network 170 may comprise a LAN and may or may not have access to a wide area network but may not provide any such access (if supported) to mobile device 100. In some implementations, network 170 may comprise multiple networks (e.g., one or more wireless networks and/or the Internet). In one implementation, network 170 may include one or more serving gateways or Packet Data Network gateways. In addition, one or more of servers 140, 150 and/or 160 may be a map server, a crowd source server, a location server and/or a navigation server.

In an embodiment, location server 160 may provide assistance data to mobile device 100 to enable or enhance the ability of mobile device 100 to determine its location. In an embodiment, location server 160 may determine the location of mobile device 100 based upon signals, photos, sensor input or other data obtained at the mobile device 100. In an embodiment, location server 160 may provide GNSS acquisition assistance, ephemeris information and/or long-term orbital information and/or terrestrial transceiver locations, identifications and other terrestrial transceiver locations.

In an embodiment, a route and/or navigation sever may determine and provide routing information and mapping information to mobile device 100. In an embodiment, map sever 150 may provide and/or update map information to mobile device 100. In an embodiment, route and/or navigation sever(s) may provide routing instructions to mobile device 100 from its current location to a requested location. In an embodiment, map server 150 may receive map segment information from mobile devices, such as verification of road closure or traffic blocking event. In an embodiment, crowd source server 140 may receive map segment information from mobile devices, such as verification of road closure or traffic blocking event. In an embodiment, map server 150 may receive map segment information from crowd source server 140.

In various embodiments, and as discussed below, mobile device 100 may have circuitry and processing resources capable of obtaining location related measurements (e.g. for signals received from GPS, GNSS or other Satellite Positioning System (SPS) satellites 110, WAN wireless transceiver 120 or WLAN or PAN local transceiver 130 and possibly computing a position fix or estimated location of mobile device 100 based on these location related measurements. In some implementations, location related measurements obtained by mobile device 100 may be transferred to a location server such as an enhanced serving mobile location center (E-SMLC) or SUPL location platform (SLP) (e.g. location sever 160) after which the location server may estimate or determine a location for mobile device 100 based on the measurements. In the presently illustrated example, location related measurements obtained by mobile device 100 may include measurements of signals (112) received from satellites belonging to an SPS or Global Navigation Satellite System (GNSS) (110) such as GPS, GLONASS, Galileo or Beidou and/or may include measurements of signals (such as 122 and/or 132) received from terrestrial transmitters fixed at known locations (e.g., such as WAN wireless transceiver 120). Mobile device 100 or a location server 160 may then obtain a location estimate for mobile device 100 based on these location related measurements using any one of several position methods such as, for example, GNSS, Assisted GNSS (A-GNSS), Advanced Forward Link Trilateration (AFLT), Multilateration, Observed Time Difference of Arrival (OTDOA) or Enhanced Cell ID (E-CID), network triangulation, Received Signal Strength Indication (RSSI) or combinations thereof. In some of these techniques (e.g. A-GNSS, AFLT and OTDOA, RSSI), pseudoranges, ranges or timing differences may be measured at mobile device 100 relative to three or more terrestrial transmitters at known locations or relative to four or more satellites with accurately known orbital data, or combinations thereof, based at least in part, on pilots, positioning reference signals (PRS) or other positioning related signals transmitted by the transmitters or satellites and received at mobile device 100. Here, servers 140, 150 or 160 may be capable of providing positioning assistance data to mobile device 100 including, for example, information regarding signals to be measured (e.g., signal timing and/or signal strength), locations and identities of terrestrial transmitters, and/or signal, timing and orbital information for GNSS satellites to facilitate positioning techniques such as A-GNSS, AFLT, OTDOA and E-CID. For example, servers 140, 150 or 160 may comprise an almanac which indicates locations and identities of wireless transceivers and/or local transceivers in a particular region or regions such as a particular venue, and may provide information descriptive of signals transmitted by a cellular base station or AP or mobile terrestrial transceiver such as transmission power and signal timing. In the case of E-CID, a mobile device 100 may obtain measurements of signal strengths for signals received from WAN wireless transceiver 120 and/or wireless local area network (WLAN) or PAN local transceiver 130 and/or may obtain a round trip signal propagation time (RTT) between mobile device 100 and a WAN wireless transceiver 120 or wireless local transceiver 130. A mobile device 100 may use these measurements together with assistance data (e.g. terrestrial almanac data such as a base station and/or access point almanac or GNSS satellite data such as GNSS Almanac and/or GNSS Ephemeris information) received from a location server 160 to determine a location for mobile device 100 or may transfer the measurements to a location server 160 to perform the same determination.

In various embodiments, location may be determined through various means, as described above. For example, in an embodiment, the mobile device 100 may determine its location with GNSS satellite signal measurements, with terrestrial transmitter signal measurements or some combination thereof. In an embodiment, the mobile device 100 may determine its location using accelerometers and/or gyros to determine, via dead reckoning, distance and direction traveled from the last known position. In an embodiment, the mobile device 100 may determine its location using a combination of signals and sensors 280; for example, a location may be determined using various signal measurements from GNSS and terrestrial transmitters and then updated using dead reckoning. From a determined location, various signal measurements can be taken from visible transmitters to obtain an indication of distance of the transmitter from a determined location. The indication of distance may include signal strength or round-trip time or time of arrival or other distance estimation methods. New signal measurements may be taken at new determined locations. By combining indications of distance to any given transmitter taken from multiple locations, whether by one device or by a plurality of devices, the location of a transmitter, such as a WAN wireless transceiver 120 or WLAN or PAN local transceiver 130, may be determined. The location of the transmitter may be determined on mobile device 100 or on a crowd sourcing server or on a location server 160 or other network-based server.

A mobile device (e.g. mobile device 100 in FIG. 2) may be referred to as a device, a wireless device, a mobile terminal, a terminal, a mobile station (MS), a user equipment (UE), a SUPL Enabled Terminal (SET) or by some other name and may correspond to a cellphone, smartphone, laptop, tablet, PDA, tracking device or some other portable or moveable device. Typically, though not necessarily, a mobile device may support wireless communication such as using GSM, WCDMA, LTE, CDMA, HRPD, Wi-Fi, BT, WiMAX, Long Term Evolution (LTE), 5th Generation Wireless (5G) or new radio access technology (NR), etc. A mobile device may also support wireless communication using a wireless LAN (WLAN), personal area network (PAN) such as Bluetooth™ or ZigBee, DSL or packet cable for example. A mobile device may comprise a single entity or may comprise multiple entities such as in a personal area network where a user may employ audio, video and/or data I/O devices and/or body sensors and a separate wireline or wireless modem. An estimate of a location of a mobile device (e.g., mobile device 100) may be referred to as a location, location estimate, location fix, fix, position, position estimate or position fix, and may be geographic, thus providing location coordinates for the mobile device (e.g., latitude and longitude) which may or may not include an altitude component (e.g., height above sea level, height above or depth below ground level, floor level or basement level). Alternatively, a location of a mobile device may be expressed as a civic location (e.g., as a postal address or the designation of some point or small area in a building such as a particular room or floor). A location of a mobile device may also be expressed as an area or volume (defined either geographically or in civic form) within which the mobile device is expected to be located with some probability or confidence level (e.g., 67% or 95%). A location of a mobile device may further be a relative location comprising, for example, a distance and direction or relative X, Y (and Z) coordinates defined relative to some origin at a known location which may be defined geographically or in civic terms or by reference to a point, area or volume indicated on a map, floor plan or building plan. In the description contained herein, the use of the term location may comprise any of these variants unless indicated otherwise.

In an embodiment, crowd source server 140 and/or map server 150 may receive road segment information from a plurality of mobile devices 100. In an embodiment, Segment information may include location of a mobile device 100, identification of the road, highway or other segment thereof that a mobile device 100 is travelling on, velocity or speed of mobile device 100, dwell time of mobile device 100 if stationary, original route information such as target road segment(s), or actual route taken information such as taken road segment(s) or any combination thereof. In various embodiments, information may be sent to the map server in real time, periodically, batched, combined with requests for updated map or route information, or any combination thereof.

In an embodiment, crowd source server 140 and/or map server 150 may contain and/or maintain historical traffic information for various road segments. In various embodiments, historical traffic information may be associated with various dates, days of the week, time of day, holidays, events and other pertinent events or time periods. In various embodiments, historical traffic information may be compared against current traffic information at the crowd source server 140 or at the map server 150. Deviations between expected traffic based on historical traffic patterns (such as those predicted by day of week, time of day, holidays, events and other pertinent events or time periods) and actual observed traffic may be utilized to identify road closures, road hazards and road blockages as well as other impediments to traffic flow such as traffic, construction, roadside distractions (such as accidents, events near the road, etc.). In an embodiment, identified road blockages, closures or other traffic impediments may be sent to mobile devices 100 as part of map information or as part of route information or as updates to information stored on mobile device 100. In an embodiment, indications of road blockages and road closures may be detected at mobile device 100 or indicated via a user interface on mobile device 100 and forwarded, along with location of mobile device 100, or road segment identification or other road segment information to crowd source server 140 or to map server 150 where it may be utilized to identify closed or impeded road segments.

FIG. 2 illustrates an embodiment of a mobile device, a non-limiting example for implementing the various methods and techniques illustrated in the figures and text herein. As shown in FIG. 2, in an embodiment, mobile device 100, which may also be referred to as a UE (or user equipment), may include one or more general-purpose processor(s) 210. The general-purpose processor 210 may sometimes be referred to by other names such as an applications processor, a general processor, a main processor or a processor. Various functionality may run on the general-purpose processor 210 such as applications, operating system functions and general mobile device functions. General-purpose processor 210 may also include multiple processors, in some embodiments including additional processors, that perform more specialized functionality, or parts thereof, such as processing related to camera sensors, video, audio and wireless signal processing such as wireless baseband processors. In an embodiment, mobile device 100 may also include a DSP 220, which may be used for various compute processing tasks such as video and graphical processing, image processing, facial identification, feature matching, scene matching, display management, GNSS signal processing, WAN signal processing, Wi-Fi signal processing and PAN signal processing. Some tasks may, in some embodiments, be split between the general-purpose processor and one or more DSPs such as location determination, where signal search, processing and correlation may happen at the DSP level while location determination may be calculated at the general-purpose processor 210.

In mobile device 100, wireless transceiver(s) such as WAN wireless transceiver 230, and WAN antenna 232, may support various wide area network (WAN) connections (e.g., Global System for Mobile Communications (GSM), Code Division Multiple Access (CDMA), Wideband CDMA (WCDMA), Long Term Evolution (LTE), 5th Generation Wireless (5G) or new radio access technology (NR), High Rate Packet Data (HRPD)) or combinations thereof. Wireless transceiver(s) 230 and 240 may be implemented by multi-mode transceivers, discrete transceivers, separate or shared antennas (232, 245) or various combinations thereof. In mobile device 100, wireless transceiver(s) such as WLAN and/or PAN wireless transceiver 240, and WLAN and/or PAN antenna 245, may support various wireless local area network (WLAN) and personal area network (PAN) connections (e.g., wireless LAN connections (e.g., Wi-Fi/802.11) and personal area network (PAN) connections (e.g., Bluetooth and ZigBee), near field communication (NFC, sometimes known as contactless (CTLS) or CTLS NFC) or combinations thereof. Wireless transceiver(s) 240 may be implemented by multi-mode transceivers, discrete transceivers, separate or shared antennas (245) or various combinations thereof.

Mobile device 100 may contain a GNSS receiver (270) and GNSS antenna 272. The GNSS receiver 270 may measure various GNSS signals 274 received from satellites belonging to an SPS or Global Navigation Satellite System (GNSS) such as GPS, GLONASS, Galileo and/or Beidou. These signal measurements may be utilized to determine location either alone or in combination with terrestrial signals such as WAN, WLAN and PAN signals.

Mobile device 100 may include various sensors and may, in some embodiments be discrete or in some embodiments, be integrated into a sensor subsystem. Sensors may include, in various embodiments, accelerometers such as 3D accelerometers, gyros such as 3D gyros, and magnetometers, often used alone or in combination to determine dead reckoning output such as heading, distance, and orientation. Sensors may be used, in an embodiment to determine velocity or speed and acceleration and/or used to determine step count and gait. Other sensors, in an embodiment, may include camera sensors, light sensors, and pressure sensors or other altimeters or other sensor types such as medical and chemical sensors.

Mobile device 100 may include a display 250. In some embodiments, display 250 may be a touchscreen capable of both displaying visual output and receiving touch or other input. The display 250 be associated with a virtual keyboard on the display, sometimes on demand, or by an actual keyboard, for character input. Mobile device 100 may also include memory 260, which may comprise FLASH, RAM, ROM, disc drive, or FLASH card or other memory devices or various combinations thereof. In an embodiment, memory 260 may contain instructions to implement various methods described throughout this description. In an embodiment, memory may contain instructions for requesting map information, for displaying map information, for requesting route information and/or displaying route information.

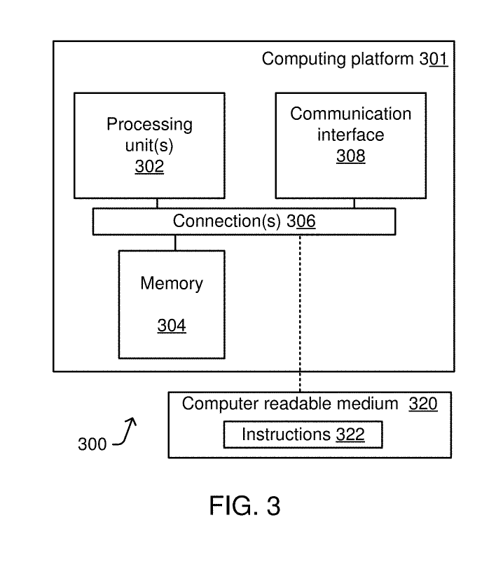

FIG. 3 illustrates a server as a non-limiting example of means for implementing the methods and techniques described herein. Referring to FIG. 3, in an embodiment, the servers 140, 150 and 160 and other network based servers, may use the computing platform 301 embodiment of FIG. 3. The computing platform may comprise one or more processors, here, processing unit(s) (302) comprising one or more general purpose processors, special processors such as graphics processors and/or communications processors or baseband processors. Computing platform 301 will include at least one communication interface 308 to send communications over network 170. The communication interface 308 may comprise a network interface card or cards or other interface for interfacing to an Intranet and/or Internet over network 170. Communication interface 308 may also comprise, in some embodiments, a wireless interface or interfaces such as WAN, WLAN and Bluetooth wireless interfaces. The computing platform may also comprise various memory (304), such as Cache, RAM, ROM, disc, and FLASH memory. In an embodiment, Computing platform 301 may also access computer readable medium 320 such as hard disk drives, tape drives, flash drives and other memory devices.

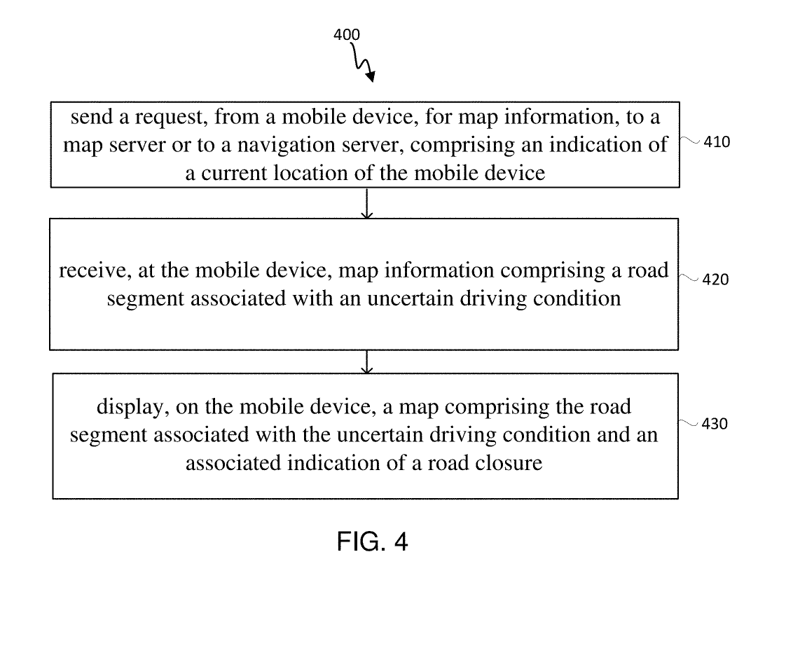

FIG. 4 illustrates a method and technique 400 for requesting map information on a mobile device. It is understood that various means may be utilized to perform the method of FIG. 4, including the use of a mobile device 100, as described in FIG. 2 and its accompanying description.

In an embodiment, in step 410, the mobile device 100 sends a request, from a mobile device, for map information, to a map server 150 or to a navigation server, comprising an indication of a current location of the mobile device. The current location of the mobile device may be determined by various means. In an embodiment, a previously stored location of the mobile device 100 is used as the current location of the mobile device. In an embodiment, the previously stored location of the mobile device 100 is used if less than a threshold amount of time has elapsed since the previously stored location was determined. In an embodiment, the previously stored location of the mobile device 100 is used if less than a threshold amount of distance has been traversed since the previously stored location was determined; this may be determined, for example, by dead reckoning with sensors, or by estimating the distance traversed based upon the maximum or average velocity or speed of mobile device 100 and multiplying by the elapsed time since the previously stored location was determined. In an embodiment, the current location of mobile device 100 is determined by its location on a navigation route. In an embodiment, the current location of the mobile device 100 is determined based on proximity to one or more terrestrial transmitters, for example, by using the location of the serving cell, the location of a nearby access point, or by using multilateration between multiple terrestrial transmitters (such as base stations and access points). In an embodiment, the current location of the mobile device is determined utilizing a GNSS-based location fix, such as by multilateration of GNSS-based signals or a hybrid combination of GNSS and terrestrial signals. In an embodiment, the map information is centered around the current location of the mobile device.

In various embodiments, the current location of the mobile device may be determined through a mobile-based technique such as GNSS or through the use of terrestrial transceivers, through a server-based technique where the mobile measures and sends ranging information from various transceivers to a server which calculates the location, for example, at location server 160, or through input from an input device such as touchscreen display 250, a keypad, voice recognition or other input means. In an embodiment, the mobile device 100 may receive GNSS signals 274 received at GNSS antenna 272 and GNSS receiver 270 and calculate location using DSP 220 and/or general-purpose processor 210. In an embodiment, the mobile device 100 may receive WAN signals 234 received using WAN antenna 232 and WAN wireless transceiver 230 and/or WLAN and/or PAN wireless signals 247 using antenna 245 and WLAN and/or PAN wireless transceiver 240 and calculate location using DSP 220 and/or general-purpose processor 210. In an embodiment, mobile device 100 may combine ranges from GNSS, WAN, WLAN or PAN or various combinations thereof. In an embodiment, assistance data such as a base station almanac may be received from a server such as location server 160 or a crowd source server. In an embodiment, GNSS assistance such as long-term ephemeris, ephemeris or satellite almanac data may be received from a location server 160. In an embodiment, a base station almanac may provide locations and identifiers for terrestrial transceivers utilized for determining ranges in combination with received signals from terrestrial transceivers such as wide area network (WAN) wireless transceiver 120, WLAN and/or PAN wireless local transceiver 130, which may be used with signal measurements from WAN, WLAN and PAN transceivers to determine ranges to the mobile device 100 and the location of mobile device 100. Similarly, GNSS assistance may be utilized with GNSS signal measurements to determine location of the mobile device.

In an embodiment, the mobile device may send a heading and a speed or velocity of the mobile device. This information may be provided to a map server 150 as part of the map request or as part of a map update request, or location, velocity or speed and heading may be provided to a crowd source server 140 so that the crowd server may utilize the information to determine traffic conditions on various road segments where crowd sourcing mobile devices 100 are present and are collecting and providing location, velocity or speed and/or heading data. If velocity or speed and/or heading are sent to the map server, for example, as part of a map request or a map update request, in some embodiments, the map server 150 may determine road status directly or the map server 150 may provide/forward the location, velocity or speed and/or heading information to a crowd source server 140 to determine road status. In an embodiment, the crowd source server 140 uses the crowd sourced data from mobile devices 100 to determine traffic and road status information for road segments. The traffic and road status information for road segments may then be sent from the crowd source server 140 to the map server 150, so that updated map data may be provided from map server 150 to mobile device 100.

In an embodiment, the mobile device sends an indication of transit on the road segment associated with the uncertain driving condition to the crowd source server 140, and/or to the map server. The indication of transit on the road segment may be utilized, in an embodiment, to determine that a road closure condition does not exist or has been eliminated (e.g., traffic is flowing again) and/or may be used to clear an uncertain driving condition designation associated with a road segment. The crowd source server 140, and/or to the map server may utilize the indication of transit on the road segment to determine if traffic on the road segment is currently flowing. If the mobile device sends an indication of transit on the road segment associated with the uncertain driving condition, the crowd source server 140 and/or to the map server may utilize the indication of transit on the road segment to determine that a road closure condition no longer exists and/or to reduce the confidence in a road closure situation. Crowd sourced data relating to the speed, heading and velocity or speed of mobile devices 100 may be utilized to determine the traffic flow on road segments on which mobile devices 100 are present.

In an embodiment, the mobile device may send a confirmation of the road closure for the road segment associated with the uncertain driving condition. This may be accomplished by displaying or presenting a visual or audio question as to whether the road closure still exists. If a response or a plurality of responses is/are received from the mobile devices regarding the existence of the road closure, the road closure status can either be continued or terminated. If mobiles on the road segment send crowd sourced information to the crowd source server 140 and/or the map server 150, the crowd sourced information (location, heading and direction) may be utilized to determine traffic flow on the road segment or it may be utilized to confirm that the road is still closed.

In an embodiment, in step 420, the mobile device 100 receives map information comprising a road segment associated with an uncertain driving condition. In an embodiment, the map information is centered around the current location of the mobile device 100. In an embodiment, the map information is based upon a navigation route and may, in some embodiments, cover area surrounding the navigation route, from the current location to a destination. In an embodiment, the map information comprises road segment information for road segments near the current location. In an embodiment, a road segment associated with an uncertain driving condition may comprise a road segment with no current crowdsourced information. In an embodiment, a road segment associated with an uncertain driving condition may comprise a road segment with no current crowdsourced information where no traffic is consistent with historical traffic information for the current time, day and location, and/or a road segment with no current crowd sourcing information where moderate or high traffic levels would be predicted by historical traffic information for the current time, day and location. In an embodiment, a road segment with no or a paucity of current crowdsourced traffic information from cars traversing that road segment, where no traffic is consistent with historical traffic information for the current time, day of week (or date, relative to special days such as holidays) and location, may be associated with both an indication of low or no data and an indication of low likelihood of a road closure or blockage (or no indication of blockage). E.g., an indication of no current data and/or an indication of low or no traffic. In an embodiment, information regarding a road segment with no or a paucity of current crowd sourced information from mobile devices traversing that segment, where moderate or high traffic levels would be predicted by historical traffic information for the current time, day, date and location, may associated with an indication of a high likelihood of a road closure, of a road closure, of a road blockage or other indication of an impassible road segment. In an embodiment, no or a paucity of current crowd sourcing information from mobile devices on a road segment comprises no or little crowd sourced mobile device information received by crowd source server 140 and/or map server 150 from mobile devices 100 on the road segment for over a predetermined threshold period of time prior to the current time (e.g., the last 10 minutes or the last hour or the last 3 hours). Depending on the type of road, the threshold could also vary, such that a rural road segment or other road segment without a lot of traffic might have a longer threshold time (e.g., one to a few hours) within which mobile devices did not provide data for that road segment before the crowd source server 140 and/or map server 150 decide that a no data condition or possible road closure condition exist. Meanwhile, a generally high traffic road segment, such as a busy highway or other high traffic road segment, might have a relatively short threshold period of time prior to the current time (e.g., the last 5 to 15 minutes) where mobile devices did not provide data for that road segment before the crowd source server 140 and/or map server 150 decide that a no data condition or possible road closure condition exist. The threshold period of time prior to the current time where mobile devices did not provide data for a particular road segment may also vary based on time of day (e.g., less time during traditional rush hour, more time during off peak times such as late at night), day of week (e.g., less time on week days, more time, all else equal, on weekends), and/or date (e.g. December 25 or January 1 versus a typical week), and also due to other variables such as known scheduled events, etc.

In an embodiment, the mobile device 100 may receive input indicating confirmation of the road closure for the road segment associated with the uncertain driving condition. For example, if the comparison of historical and current traffic levels is done at the map server 150 or at the crowd source server 140 (rather than at the mobile device), the map server 150 or the crowd source server 140 may send notification to the mobile device of an updated status for a road segment confirming or clearing road closure status for the road segment. In an embodiment, the mobile device 100 could use confirmation of the road closure for the road segment, for example, as might be provided by the crowd source server 140 or the map server 150, to confirm status of the road segment as closed and to trigger a map update, wherein the road segment is redrawn or labeled such that a road closure status is associated with the road segment as displayed on display 250. In an embodiment, this may trigger an update of the map on display 250, a request for updated map information, or a re-rendering of the map segment and its status information on display 250.

In an embodiment, the mobile device may receive public scheduled road closure information. For example, road closure information associated with known scheduled events such as road construction, parades, and other road closing/blocking events as provided by a government entity may be provided to or otherwise obtained by the mobile device 100 to determine road closure status for various road segments. In an embodiment, road closure information associated with known scheduled events such as road construction, parades, and other road closing/blocking events may be downloaded from a government entity to a crowd source server 140 and/or a map server 150 such that the crowd source server 140 and/or the map server 150 may update map status information and provide the updated map status information to a plurality of mobile devices 100.

In an embodiment, the mobile device 100 may compare historical and current traffic information. For example, in an embodiment, the mobile device 100 may receive, at the mobile device, historical traffic information for the road segment associated with the uncertain driving condition; receive, at the mobile device, current traffic information for the road segment associated with the uncertain driving condition; compare, at the mobile device, the historical traffic information for the road segment associated with the uncertain driving condition and the current traffic information for the road segment associated with the uncertain driving condition; and determine the uncertain driving condition comprises the road closure. In an embodiment, the historical traffic information and current traffic information are provided by the crowd source server 140 and/or by the map server 150 and the comparison may be done on the mobile device; in an embodiment, the comparison of the historic and current traffic information and the determination that a road closure exists may, instead, be determined at the map server 150 or at the crowd source server 140, combined with the map at the map server 150 and sent to the mobile device as part of a map update at the mobile device.

If the historical traffic information shows that the traffic on the road segment associated with the uncertain driving condition is historically low, at an equivalent or comparable time and location and if the current traffic information similarly suggests that traffic on the road segment associated with the uncertain driving condition is comparable to the historic traffic, the status of the road segment may remain uncertain or undetermined or, in an embodiment, the status of the road segment may be set to or remain in an unimpeded traffic status, or in an embodiment, a longer time threshold may be applied, during which no through traffic is detected, prior to determining that there is likely a road closure on a particular road segment.

In an embodiment, the road closure status of a road segment that has historically high traffic levels may be determined more quickly (e.g., by using a shorter threshold time applied to the period during which to crowd source data is received from mobile devices 100 to determine that a road closure exists) by crowd sourcing the location information (e.g., location, velocity or speed and/or heading information) of mobile devices on that road segment and determining the lack of crowd sourced information on that road segment for a relatively smaller time threshold. For example, if a segment of highway historically has one car per second throughput, a road closure event such as a scheduled closure or road closing accident or other road closing event could be confidently determined quickly, perhaps within minutes or less, based on the difference between historic traffic levels and the current lack of traffic on a particular road segment.

Note that the uncertain driving condition is based on a lack of or a paucity of crowd sourced location information (e.g., location, velocity or speed and/or heading information) from mobile devices on a given road segment over a threshold period of time, the threshold period of time being variable in some embodiments as previously discussed. This may be determined, even in the absence of historic traffic data on the mobile device or server that is making the determination. Furthermore, the uncertain driving condition may remain associated with a particular road segment until the threshold period of time appropriate for a given road segment at a particular time period (time, date, day of week, holiday or not, etc.), at which point a road closure status may be assigned to the given road segment, or until sufficient crowd sourced location information (e.g., location, velocity or speed and/or heading information) is received from mobile devices on a given road segment to determine that the road segment is open for traversal, which will trigger some embodiments to display a traffic status for the road segment, for example, green for unimpeded traffic, yellow for impeded traffic and red for greatly impeded traffic. Thus, the mobile device (or in some embodiments the crowd source server 140 or the map server 150) may determine that the uncertain driving condition comprises a road closure by determining the historical traffic information for the road segment associated with the uncertain driving condition is inconsistent with the current traffic information for the road segment associated with the uncertain driving condition.

While we have described comparing historic and current traffic on a handset, the above discussion also applies to server-based implementations. The comparison of historic traffic levels and current traffic levels to determine if there is a road closure may, in some embodiments, be performed at the crowd source server 140 and/or the map server 150 or on an application server. Furthermore, in an embodiment, the road segment information may be uploaded by mobile devices to the crowd source server 140, which may determine the current traffic levels on a road segment based upon crowd sourced uploads from mobile devices 100. The crowd source server 140 could then send the current traffic information and, in some embodiments, the historical traffic information to the map server 150 and let the map server 150 determine the road segment analysis based on the historic and current traffic information. The map server 150 may then generate an updated map or map information, which may be downloaded to various mobile devices 100.

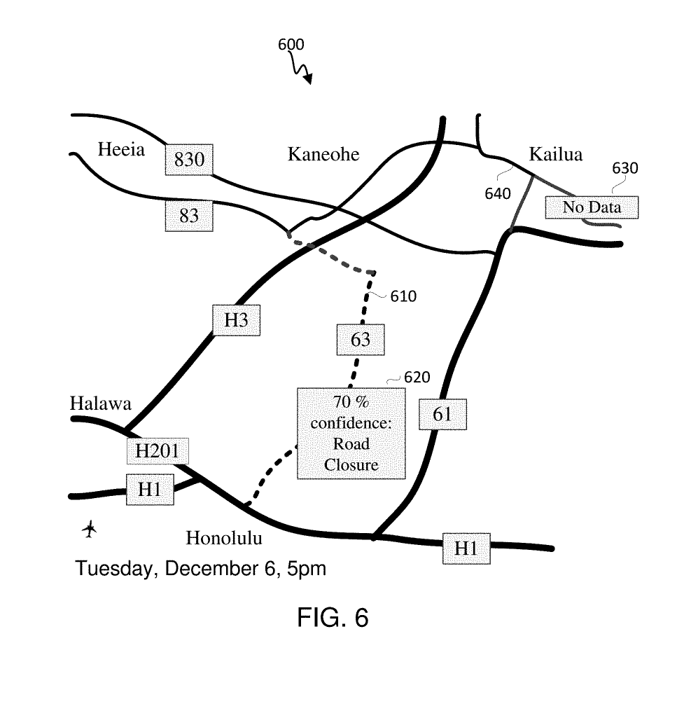

In an embodiment, in step 430, the mobile device 100 displays a map comprising the road segment associated with the uncertain driving condition and an associated indication of a road closure. It is understood that a road closure may, in various embodiments, comprise a scheduled road closure, road closure due to road repair and/or maintenance (e.g., tree trimming, lane painting), road closure due to an accident, road closure due to mud slides, snow or other obstacles, or other events (such as marathons, parades and marches) that would prevent a vehicle from traversing the affected road. In an embodiment, the mobile device may display, on a display, an updated map, based at least in part upon elimination of the uncertain driving condition, comprising the road segment associated with the eliminated uncertain driving condition and an indication of driving condition for the road segment associated with the eliminated uncertain driving condition. In an embodiment, displaying an updated map occurs if the mobile device is still in the vicinity of the road segment associated with the eliminated uncertain driving condition and if the mobile device is displaying a map comprising the road segment associated with the eliminated uncertain driving condition when the uncertain driving condition is eliminated or cleared. Reference FIG. 6 and the discussion thereof, for further details regarding an exemplary embodiment of a map with a road segment associated with an uncertain driving condition.

In an embodiment, the map may be utilized by a navigation application, displaying current location and route. If a road segment associated with a road closure is part of a proposed or selected route, for the navigation application, the navigation application on the mobile device may display route alternatives comprising a route not including the road segment associated with the uncertain driving condition and a route comprising the road segment associated with the uncertain driving condition associated with a notification of a potential road closure. It is understood that, for the purposes of this disclosure, the uncertain driving condition comprises both an unknown driving condition (e.g., where no crowd source data or a paucity of crowd source data is received and therefore it is not known if the road is closed or not) or a road closure condition where the lack of crowd source data in conjunction with otherwise historically high traffic levels for the same segment suggest that a road closure exists.

It is also understood that, in an embodiment, varying levels of confidence may be associated with a given road closure; for example, based upon the length of time for which there is no crowd sourced data (there would be more confidence in a road closure designation associated with longer the time intervals without received crowd sourced data). Also, reports uploaded by mobiles that confirm a road closure condition, such as those from a user selecting a screen selection or pressing a button that confirms a road closure, may be used to increase the confidence in a road closure. Those reports may be utilized, in an embodiment, to update the map information associated with a given road segment. In some embodiments, the confidence level 620 associated with a road closure status for a given road segment may be displayed, either associated with the road segment on a map, orally reported, associated with a navigation route selection, or otherwise reported to the user via display output, audio output or other output. In an embodiment, other indications of data uncertainty may be utilized such as color coding, dashed line road segments, flashing road segments or other indicators of traffic and/or road status uncertainty associated with a road segment.

In an embodiment, when the road blockage or road closure is cleared, mobile device 100 displays an updated map, based at least in part upon elimination of the uncertain driving condition, comprising the road segment associated with the eliminated uncertain driving condition and an indication that the road segment associated with the eliminated uncertain driving condition is available. In an embodiment, the elimination of the road closure may be determined on map server 150 or crowd source server 140 (or other traffic data analyzing server) or, if historical traffic conditions and updated current traffic conditions are available on the mobile device, some embodiments may determine elimination of the road closure on the mobile device. In some embodiments, the indication that the road segment associated with the eliminated uncertain driving condition is available may be explicit via messaging or status flag while in some embodiments, the road segment status may be updated to reflect current traffic levels or other indications of an open/traversable status. In embodiments where elimination of the road closure is determined on a server, an indication of the elimination of the road closure (which may be explicit or may be implicit via the provision of traffic data for the road segment) may be forwarded to mobile device 100 as part of updated map information sent to mobile device 100. For example, information regarding the road segment that was associated with the uncertain driving condition may be sent to the mobile device showing current traffic levels or indicators of traffic levels (for example, color coding the segment as green, red, yellow or other color). In an embodiment, the elimination of the road closure or blockage may be based upon the receipt of crowd sourced traffic information, for example, at the map server 150 or crowd source server 140, or, in mobile-based implementations, summary traffic information likely from a crowd-source server 140 or from a transportation data server, for the road segment associated with the eliminated uncertain driving condition. In an embodiment, elimination of the road closure or blockage may be based upon public closure information or traffic information, as may be available on the Internet or from public transportation agencies (e.g., from a transportation server or application server) or from private traffic information providers; the traffic and/or closure information may be associated with dates and times and/or duration associated with the road closure, if any. In an embodiment, elimination or confirmation of the road closure or blockage may be based upon user input sent from a mobile device, such as via the receipt of user input verifying or denying the ongoing presence of a road closure. In an embodiment, determining that the road closure has been eliminated may be determined directly on the map server 150 which may receive crowd sourced data and update the status of road segments or the mobile data may be sent to a crowd source server 140, which would determine the traffic status and forward the updated status to a map server 150 (or to mobile device 100, depending on whether the eliminated road closure is determined at the map server 150 or the mobile device 100). In an embodiment, received crowd sourced information for the road segment associated with the eliminated uncertain driving condition may be compared with historical information for the same road segment at the crowd source server 140 or at the map server 150 to determine if the crowd sourced information for the road segment is consistent with historical traffic information for the road segment within a predetermined threshold or percentage. For example, if a road is normally (historically) empty or has very low traffic at a particular time of day and day of week, and shows a lack of crowd sourced data (e.g., there are few or no mobile devices sending traffic and/or driving information to the crowd source server 140), the paucity of crowd sourced data may indicate that nobody is travelling on the road segment but that the road is drivable without issue. However, if a road is normally (historically) busy or has high traffic at a particular time of day and day of week (for example, during rush hour on a week day), and shows a lack of crowd sourced data at the particular time (where the road is historically busy), the paucity of crowd sourced data may indicate that nobody is travelling on the road segment due to a road closure, large accident, landslide, public event or other road closing cause, and that the driver should avoid (or at least consider avoiding) that segment of road and seek alternative route.

In an embodiment, an indication that the road segment associated with the eliminated uncertain driving condition is available comprises an indication of road status associated with driving conditions associated with the road segment. In an embodiment, the road segment associated with the eliminated uncertain driving condition may be displayed on display 250 with an indication of road status associated with driving conditions consistent with on the road segment. For example, free flow of traffic may be indicated as green, moderate traffic as yellow and significant traffic slowing as red.

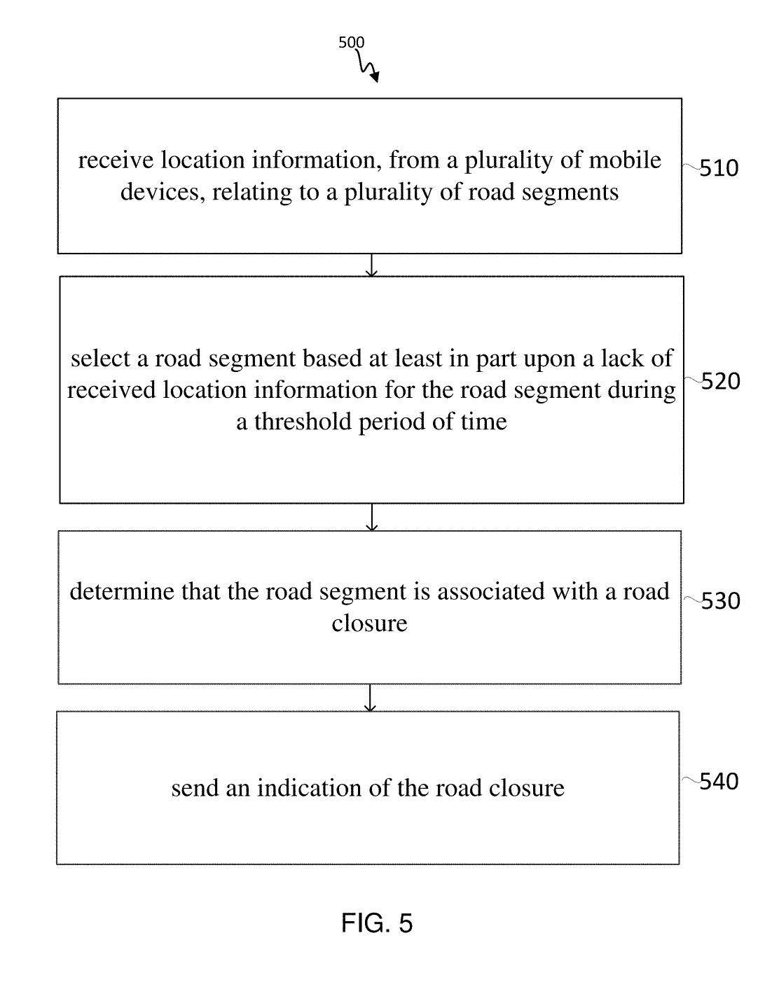

FIG. 5 illustrates a method and technique 500, on one or more servers (e.g., a crowd source server 140 and/or a map server 150), for receiving information from mobile devices (e.g., location, velocity or speed and/or heading), relating to a road segment in which little or no location is received from mobile devices, and the determination that the lack of data for that road segment is associated with an unblocked road with a low traffic condition or with a road closure condition. It is understood that various means may be utilized to perform the method of FIG. 5, including the use of a computing platform 301, as described in FIG. 3 and its accompanying description.

In step 510, the crowd source server 140 and/or map server 150 receives location information from a plurality of mobile devices 100, relating to a plurality of road segments. In an embodiment, mobile devices 100 send information regarding their location and, in some embodiments, velocity or speed and heading, to a crowd source server 140 which is utilized to collect data from mobile devices 100 and to analyze the data, or, in other embodiments, to a map server 150. Note that a map server 150 generally is utilized to generate maps and associated road status information and to provide the map and status information to mobile devices while the crowd source server 140 would collect and analyze the location, velocity or speed and heading information (or subsets thereof) from mobile devices; the crowd source server would, in such an embodiment, determine the status of road segments, and in some embodiments, locations of accidents and road blockages, and then provide road status information to the map server 150, which would combine this information with the map information to provide map information with road status to mobile devices. However, in some embodiments, the map server 150 could also perform the crowd sourcing of mobile device 100 data and the analysis of the mobile device 100 data. The mobile device 100 may provide location related information (e.g., location, heading and velocity or speed) when requesting map data and/or requesting map data updates; that data could be provided to a crowd source server 140 and/or a map server 150.

In step 520, the crowd source sever 140 and/or map source server selects a road segment based at least in part upon a lack of received location information for the road segment during a threshold period of time. The selected road segment has uncertain status based on a lack of crowd sourced data. That status can be further determined or determined with more or less confidence in step 530 based on public closure information such as that put out by some municipalities, mobile device 100 crowd sourced reports confirming or denying the road closure, road sensor information, traffic information and other sources of information relative to movement of devices on a particular road segment.

The threshold period of time is selected to be informative relative to whether the road segment is obstructed. Too short a threshold period of time may result in false decisions of road blockage and too long a threshold period of time may result in untimely or out of date status information. Furthermore, time of day, date, holiday conditions, day of week, type of road, typical traffic on a particular road or road segment, may impact what a useful threshold period of time is. For example, in a road with normal low traffic conditions such as a rural road or a road late at night, a longer threshold may be utilized to prevent false positives in detection of road blockages, based on no crowd sourced mobile devices 100 transiting that road segment. However, in a road with typically high traffic conditions such as a highway or a popular/larger road, or a road during peak usage times, a shorter threshold time may be utilized based on an assumption or historical record that there would normally be large numbers or crowd sourced mobile devices 100 transiting the road segment, possibly as modified by other factors such as time of day, day of week, date, holidays, etc. Non-permanent factors such as road construction or other traffic affecting events may also be considered in some embodiments.

Thus, in some embodiments a single threshold period of time (e.g., 30 minutes or an hour) could be utilized with multiple road types. However, in other embodiments, the threshold period of time may vary depending on the road, road type, time of day, day of week, and other factors, and/or based on historical traffic on the road segment, possibly as adjusted for factors like time of day, day of week, holidays, etc. For example, road closures on a highway that normally that has high traffic flow could be detected quickly, possibly within a few minutes of traffic being cut off/diverted, while road closures on a rural road that normally has low traffic flow might take hours or more to detect. In some embodiments, the road closure determination might only be performed for high flow roads that can be more reliably predicted. In other embodiments, the crowd source information can be correlated against actual road closures to determine the proper threshold period of time for road closure detection. In some embodiments, a lack of or paucity of crowd sourced traffic information from a road segment, may be associated with a probability of a road closure. The probability of a road closure may increase as the time with no traffic increases and/or based on the difference between the expected amount of crowd sourced vehicles and the actual/observed amount of crowd sourced vehicles traversing a particular road segment. Also, in some embodiments, a mobile device may contain a user interface feature that allows a user to input confirmation of a road closure event or lack thereof, which can be used to update the confidence in the road closure or to update the status. For example, a user driving by or on the road segment in question may be queried, perhaps with a voice query or written query, in regard to whether a road closure exists. Finally, note that larger municipalities may provide public information on officially scheduled road closures (for example, for road re-paving). However, the publicly provided information often does not include information on non-municipal road closures such as landslides, snow blockages, etc., and, in any case, is often not available for a large number of smaller and moderately sized municipalities.

In step 530, the crowd source sever 140 and/or map source server determines that the road segment is associated with a road closure. A lack of crowd sourced data for a particular road segment indicates an uncertain status for that road segment due to lack of information. The status can be further determined and/or a confidence level may be adjusted in step 530 based on additional information in regard to the road segment for which crowd sourced information is unavailable or sparse. For example, using public closure information such as that put out by some municipalities, mobile device 100 crowd sourced reports confirming or denying the road closure, road sensor information, traffic information and other sources of information relative to movement of devices on a particular road segment, the actual status of the road segment may be determined. For example, public road closure information can be used to increase the confidence in and/or confirm the road closure. Crowd sourced information or road sensor information showing greater traffic on alternative road segments can be used to increase the confidence in and/or confirm a road closure. In an embodiment, records for historical traffic on a road segment may be compared to crowd sourced traffic on the same road segment with the intent of determining whether it is normal for that road segment to have low or no traffic under the current circumstances (date, time, day of week, month, and/or holiday status, etc.), or if the current traffic is significantly reduced or eliminated relative to historical traffic norms for that road segment. In some embodiments, the comparison may utilize an average traffic flow for the road segment and in some embodiments the comparison may utilize a variable historic traffic level that accounts for traffic differences due to holidays, day of week, time of day, and/or date, and/or other traffic affecting variables. In some embodiments, historical averages may be utilized on low traffic roads while situation (time, date, day of week, and/or holiday, etc.) related traffic predictions may be utilized on high traffic roads, such as highways or large municipal roads, that show high traffic flow at least during peak hours, but may, in some instances show significantly reduced traffic during off-peak hours.

In embodiments where the traffic determinations are done on a crowd source server 140 and the maps are sent to the mobile device from a map server 150 (e.g., such as a map application server or other server providing map information to mobile devices), the crowd source server 140 will send updated status information to the map server 150 that may be utilized to update the status of road segments for maps that are provided to mobile devices 100.

In step 540, a server (e.g., such as crowd source server 140 or map server 150, or navigation server, or other server), sends an indication of the road closure. In an embodiment, the indication of a road closure may be sent to at least one mobile device. In an embodiment, the indication of the road closure may be sent from one server to another server; for example, the indication of the road closure may be sent from a crowd source server to a map server or to a navigation server or both for use, by the map server or navigation server in determining maps and/or routes and/or navigation instructions. The indication of the road closure may be sent to a mobile device in response to a request for a map or in response to a request for a map update, or it may be sent proactively to a device utilizing a map application. The request for a map, in an embodiment, is associated with a location of the mobile device 100. The request for a map may also include, in an embodiment, velocity or speed and heading information that may be utilized by the map server to determine what direction relative to the location of mobile device 100 to send map information for and/or how much map information and/or the geographic extent of the map information to send to mobile device 100. In an embodiment where the indication of the road closure is sent from one server to another server, such as from a crowd sourcing server to a navigation and/or routing server or to a map server, the navigation/routing and/or map server may use the road closure determination or inference to influence its selection/ranking of proposed routes and/or to reclassify the status of the affected road segment in the map database. The road closure inference may, in some embodiments, be displayed on the mobile device; for example, when a navigation or routing server provides a plurality of potential routes to the mobile device, the mobile device may exclude routes with closed segments or show them but indicate a risk of large delay or subsequent need to re-route, or combination thereof. The displayed recommendations may be, in an embodiment, etc. determined by the navigation server or by the mobile device or combination thereof. For example, in an embodiment, a mobile device may include navigation configuration options that influence or determine how and when road closure segments are displayed and/or utilized for navigation and maps. For example, in an embodiment, the navigation or map server may provide road segment closure information and, in some embodiments, a confidence level in the road segment closure (e.g., likelihood that the road is really closed, based on, for example, the magnitude of the difference between historical and/or predicted traffic for a particular time, location, and date or other factors and the crowd sourced traffic (or lack thereof) such that a road segment that is normally empty at a particular time, date, and/or day might have low confidence in a road closure (based on low or no crowd sourced traffic) while a road segment that is normally busy at a particular time, date, and/or day might have high confidence in a road closure (based on low or no crowd sourced traffic)) In an embodiment, the confidence in the road closure may be utilized by the navigation or map server to send different routes or to rank routes higher that do not have a high confidence road closure, or confidence about a threshold. In an embodiment, the confidence in the road closure may be sent to the mobile device by the navigation or map server and the mobile device may determine whether to display only unaffected routes or to rank routes higher that do not have a high confidence road closure, or confidence about a threshold and/or whether to indicate particular map segment(s) as closed, depending on the confidence level associated with a road closure on the particular map segment(s).

The indication of the road closure is sent along with an indication of the identity of the road segment to which the road closure pertains. In an embodiment, the indication of the road closure is also associated with extent information for a road closure. For example, the end points of a road closure or coverage of the road closure may be specified, where only part of a road is closed and other parts of the road (or highway) remain open. The end points of the road closure may be determined by, typically by the crowd source server 140 or other server doing the crowd source data analysis, by the presence of crowd sourced data from cars on some segments of the road segment but not on other parts of the road segment. In an embodiment, local only traffic may also be detected by the crowd source server 140 or other server doing the crowd source data analysis (such as the map server 150 in some embodiments) based upon whether the mobile devices traverse the entire road segment or only access local destinations within the road segment.

FIG. 6, in an exemplary embodiment of a map with a road segment associated with an uncertain driving condition. In an embodiment, display 250 may display map information and/or route information. In an embodiment, map information may comprise road segments surrounding the location of mobile device 100. In an embodiment, one or more road segments may be identified on the display 250 based at least in part on segment status. For example, an unimpeded road segment may be represented as a green line on display 250 while a road segment with slowed traffic may be indicated as yellow or red line on a map on display 250. A road segment 610 with a road closure might be displayed with a dotted line or a designated color (for example, a color not typically used for traffic status (green, yellow, red) such as purple) and/or with a notification/message (in some embodiments associated with a confidence level 620 or likelihood level) of a road closure or a possible road closure. A road segment 640 with little or no traffic will have a lack of or paucity of recent crowd sourced data and may be represented by a designated a color or a pattern (e.g., dashes instead of solid line; or white instead of green, yellow or red) or by a written label 630, “no data.” On a road segment 640 with no current crowdsourced information, where no traffic is consistent with historical traffic information for the current time, day and location, may be indicated on a map, differently (for example labeled to note no data or low data for that road segment, such as white or dashes), from road segment 610 with no current crowd sourcing information (received from crowd sourcing mobile devices 100) where moderate or high traffic levels would be predicted by historical traffic information for the current time, day and location, which would suggest a road closure or blockage of some sort. In an embodiment, road segments with no current crowd sourcing information where moderate or high traffic levels would be predicted by historical traffic information for the current time, day and location may be indicated as closed or otherwise unavailable such as with a label, “possible road closure” or, as in confidence level 620, “70% confidence: Road Closure.” In an embodiment, road segments indicated as closed may be displayed on display 250 as flashing segments or as broken segments or as segments separated from other roads by a discontinuity or in a dedicated color or other indications to designate impassibility or unavailability. In an embodiment, a road segment 640 with no current crowdsourced information, where no (or little) traffic is consistent with historical traffic information for the current time, day and location, may be indicated on a map as a different color code such as a white or as a light-colored line segment to indicate a lack of current crowd sourced traffic information or labeled with a written label 630, “no data.” In an embodiment, closed road segments or otherwise obstructed road segments may be further designated or color coded on display 250 based on confidence in the road closure, for example, by displaying an associated confidence number or by displaying the segment in different shades or thicknesses based on the associated confidence number. In an embodiment, confidence in a road closure may be determined on map server 150 or crowd source server 140 and forwarded to mobile device 100 as part of map information sent to mobile device 100.

Reference throughout this specification to “one example”, “an example”, “certain examples”, “in an embodiment”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or “in an embodiment” or other like phrases in various places throughout this specification are not necessarily all referring to the same feature, example, and/or limitation. Furthermore, the particular features, structures, or characteristics may be combined or modified in one or more examples and/or features and across various embodiments. The specified embodiments are not intended to be limiting relative to implementations, which may vary in detail; one skilled in the art will realize that other non-specified embodiments may also be used with or to modify the described embodiments.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WAN”), a wireless local area network (“WLAN”), a wireless personal area network (PAN), and so on. The term “network” and “system” may be used interchangeably herein. A WAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, Long Term Evolution (“LTE”), Fifth Generation (“5G”) or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). CDMA2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a PAN may comprise a Bluetooth network, an IEEE 802.15x, comprising a Zigbee network, for example. Wireless communication implementations described herein may also be used in connection with any combination of WAN, WLAN or PAN.

In another aspect, as previously mentioned, a wireless transmitter or access point may comprise a wireless transceiver device, utilized to extend cellular telephone service into a business or home. In such an implementation, one or more mobile devices may communicate with a wireless transceiver device via a code division multiple access (“CDMA”) cellular communication protocol, for example.

Techniques described herein may be used with a satellite positioning system (“SPS”) that includes any one of several global navigation satellite systems (“GNSS” such as the Global Positioning system “GPS”, the Russian GLONASS system and the European Union's Gallileo system and the Chinese BeiDou and BeiDou-2 systems) and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable storage medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, FLASH, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable storage medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

What is claimed is:

1. A method of displaying a map on a mobile device, comprising:
sending a request for map information, from the mobile device, to a server, the request comprising an indication of a current location of the mobile device;
receiving, at the mobile device, the map information comprising a road segment associated with an uncertain driving condition; and
displaying, on the mobile device, the map comprising the road segment associated with the uncertain driving condition and an associated indication of a road closure.

2. The method of claim 1, wherein sending the request for the map information further comprises: sending, from the mobile device, a heading and a speed of the mobile device.

3. The method of claim 1, wherein sending the request for the map information further comprises: sending, from the mobile device, an indication of transit on the road segment associated with the uncertain driving condition.

4. The method of claim 1, further comprising: sending, from the mobile device, a confirmation of the road closure for the road segment associated with the uncertain driving condition.

5. The method of claim 1, further comprising: receiving, at the mobile device, input indicating confirmation of the road closure for the road segment associated with the uncertain driving condition.

6. The method of claim 1, further comprising: receiving, at the mobile device, public scheduled road closure information.

7. The method of claim 1, further comprising:
receiving, at the mobile device, historical traffic information for the road segment associated with the uncertain driving condition;
receiving, at the mobile device, current traffic information for the road segment associated with the uncertain driving condition;
comparing, at the mobile device, the historical traffic information for the road segment associated with the uncertain driving condition and the current traffic information for the road segment associated with the uncertain driving condition; and
determining that the uncertain driving condition indicates the road closure.

8. The method of claim 7, wherein determining that the uncertain driving condition indicates the road closure comprises determining that the historical traffic information for the road segment associated with the uncertain driving condition is inconsistent with the current traffic information for the road segment associated with the uncertain driving condition.

9. The method of claim 1, further comprising: displaying route alternatives.

10. The method of claim 1, further comprising displaying an indication of data uncertainty.

11. The method of claim 1, further comprising displaying, on the mobile device, an updated map, based at least in part upon elimination of the uncertain driving condition.

12. A mobile device for displaying a map, comprising:
one or more processing units; and
a display coupled to the one or more processing units; and
a wireless transceiver coupled to the one or more processing units; wherein the one or more processing units are configured to:
send a request for map information, via the wireless transceiver, to a server, the request comprising an indication of a current location of the mobile device;
receive, via the wireless transceiver, the map information comprising a road segment associated with an uncertain driving condition; and
display, on the display, the map comprising the road segment associated with the uncertain driving condition and an associated indication of a road closure.

13. The mobile device of claim 12, wherein the one or more processing units configured to send the request for the map information are further configured to send, from the mobile device, a heading and a speed of the mobile device.

14. The mobile device of claim 12, wherein the one or more processing units configured to send the request for the map information are further configured to send an indication of transit on the road segment associated with the uncertain driving condition.

15. The mobile device of claim 12, wherein the one or more processing units configured to send the request for the map information are further configured to send a confirmation of road closure for the road segment associated with the uncertain driving condition.

16. The mobile device of claim 12, wherein the one or more processing units are further configured to receive input indicating confirmation of the road closure for the road segment associated with the uncertain driving condition.

17. The mobile device of claim 12, wherein the one or more processing units are further configured to receive, at the mobile device, public scheduled road closure information.

18. The mobile device of claim 12, wherein the one or more processing units are further configured to:
receive historical traffic information for the road segment associated with the uncertain driving condition;
receive current traffic information for the road segment associated with the uncertain driving condition;
compare the historical traffic information for the road segment associated with the uncertain driving condition and the current traffic information for the road segment associated with the uncertain driving condition; and
determine that the uncertain driving condition indicates the road closure.

19. The mobile device of claim 18, wherein the one or more processing units configured to determine the uncertain driving condition indicates the road closure comprise one or more processing units configured to determine that the historical traffic information for the road segment associated with the uncertain driving condition is inconsistent with the current traffic information for the road segment associated with the uncertain driving condition.

20. The mobile device of claim 12, wherein the one or more processing units are further configured to display route alternatives.

21. The mobile device of claim 12, wherein the one or more processing units are further configured to display an indication of data uncertainty.

22. The mobile device of claim 12, wherein the one or more processing units are further configured to display, on the mobile device, an updated map, based at least in part upon elimination of the uncertain driving condition.

23. A non-transitory computer-readable medium, having stored thereon computer-readable instructions to cause a processor to:
send a request for map information, from a mobile device, to a server, comprising an indication of a current location of the mobile device;
receive, at the mobile device, the map information comprising a road segment associated with an uncertain driving condition; and
display, on the mobile device, a map comprising the road segment associated with the uncertain driving condition and an associated indication of a road closure.

24. The non-transitory computer-readable medium of claim 23, wherein the computer-readable instructions are further configured to cause the processor to display route alternatives.

25. The non-transitory computer-readable medium of claim 23, wherein the computer-readable instructions are further configured to cause the processor to display an indication of data uncertainty.

26. A mobile device for displaying a map, comprising:
means for sending a request for map information, from the mobile device, to a server, comprising an indication of a current location of the mobile device; and
means for receiving, at the mobile device, the map information comprising a road segment associated with an uncertain driving condition;
means for displaying, on the mobile device, the map comprising the road segment associated with the uncertain driving condition and an associated indication of a road closure.

27. The mobile device of claim 26, further comprising:
means for receiving, at the mobile device, historical traffic information for the road segment associated with the uncertain driving condition;
means for receiving, at the mobile device, current traffic information for the road segment associated with the uncertain driving condition;
means for comparing, at the mobile device, the historical traffic information for the road segment associated with the uncertain driving condition and the current traffic information for the road segment associated with the uncertain driving condition; and
means for determining the uncertain driving condition comprises the road closure.

28. The mobile device of claim 27, wherein the means for determining the uncertain driving condition indicates the road closure comprises: means for determining the historical traffic information for the road segment associated with the uncertain driving condition is inconsistent with the current traffic information for the road segment associated with the uncertain driving condition.

29. The mobile device of claim 26, further comprising: means for displaying route alternatives.

30. The mobile device of claim 26, further comprising means for displaying an indication of data uncertainty.
